(19) United States
(12) Patent Application Publication
(10) Pub. No.: US 2015/0106805 A1
(43) Pub. Date: Apr. 16, 2015

(54) ACCELERATED INSTANTIATION OF CLOUD RESOURCE

(71) Applicant: Cisco Technology, Inc., San Jose, CA (US)

(72) Inventors: Bob Melander, Stockholm (SE); Hareesh Puthalath, Stockholm (SE)

(73) Assignee: Cisco Technology, Inc., San Jose, CA (US)

(21) Appl. No.: 14/261,141

(22) Filed: Apr. 24, 2014

Related U.S. Application Data
(60) Provisional application No. 61/891,190, filed on Oct. 15, 2013.

(51) Int. Cl. G06F 9/455; H04L 12/911

(52) U.S. Cl. CPC G06F 9/45537; H04L 47/70
USPC 718/1

(57) ABSTRACT

The subject disclosure relates to a method for instantiating cloud resources that are provided as service virtual machines. In one embodiment, a cloud service management system maps each one of the multiple abstraction layer slots to a virtual context of a logical resource. The virtual context is hosted by a respective virtual machine that is part of a pool of virtual machines. The system identifies an available abstraction slot from the multiple abstraction layer slots and reserves the slot so that the corresponding virtual context of the logical resource can be served to a requesting device. The system then marks the available abstraction layer slot as unavailable. Systems and computer readable media are also provided.

### RELATED APPLICATIONS

This application claims priority from U.S. Provisional Patent Application Ser. No. 61/891,190 filed Oct. 15, 2013, which is incorporated by reference herein in its entirety.

### BACKGROUND

1. Technical Field

The subject technology relates to a method for instantiating cloud resources that are provided as service virtual machines. In particular, aspects of the technology provide systems and methods for near-instantaneous creation of logical resources that are hosted on service virtual machines in a cloud computing environment.

2. Introduction

Through virtual machine technology, cloud computing is changing the landscape of network-based services by allowing customers (also known as “tenants”) to use a service provider's virtualized computing assets, such as virtual processors, virtual storage, and virtual network resources, instead of having to purchase and own all of the necessary equipment outright. Notably, cloud computing providers offer their services according to several fundamental models, including, for example, Infrastructure-as-a-Service (IaaS) and Platform-as-a-Service (PaaS). Traditionally, IaaS has provided logical infrastructure resources like virtual machines (VMs), virtual networks, or virtual storage while PaaS has provided resources with higher abstraction levels. However, over the years the boundary between IaaS and PaaS has become increasingly blurry.

Cloud service management (CSM) systems used in Infrastructure-as-a-Service (IaaS) and Platform-as-a-Service (PaaS) environments can provide logical network resources, such as virtual routers, virtual firewalls, etc., to their tenants. In both IaaS and PaaS, logical resources are made available through cloud APIs, such as the Amazon® Web Services API and the Openstack® API. Behind the covers, these resources can be implemented in a variety of ways; for example, using physical devices or virtual contexts inside such devices, and using VMs or traditional software. Typically, a combination of the aforementioned methods is used.

When logical resources in a cloud service are implemented using VMs, the time needed to create the necessary logical resources can be substantial compared to when dedicated physical devices are used. In particular, physical machines are typically pre-provisioned and always ready for use, while logical resources are often created on demand. Thus, a logical resource can be hit with a time penalty in terms of getting the service VM that hosts the resource ready and in service. This extra preparation time can include, but is not limited to: (a) time for selecting the right host machine that meets the customer's requirements, (b) time for creating the VM assets, (c) time for copying a boot image to the host, and (d) time for bootstrapping the boot image.

Tenants, on the other hand, may have a different kind of expectation for these logical resources due to the highly interactive and dynamic nature of the needs of these resources. For example, when a web server is suddenly hit with unexpected spike in network traffic, the tenant might want additional resources, such as virtual routers, instantiated and deployed in a matter of seconds, not in the next half hour. Such lags are undesirable because they reduce user experience and make application service design using the cloud services more complicated.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 is a schematic block diagram of an example computer network including nodes/devices interconnected by various methods of communication;

FIG. 2 is a schematic block diagram of an example simplified computing device;

FIG. 3 is a schematic block diagram illustrating an example of a cloud service management system;

FIG. 4 is a schematic block diagram illustrating an example system featuring a virtual machine mapped to an abstraction layer;

FIG. 5 is a schematic block diagram illustrating another example system featuring a service VM pool, an abstraction layer, and client devices;

FIG. 6 illustrates an example of a desired range for a number of available resources, according to some implementations;

FIGS. 7A-7D are schematic block diagrams illustrating an example scheduling function operation;

FIG. 8 illustrates an example method for creating a logical resource;

FIG. 9 illustrates an example method for performing VM pool maintenance;

FIG. 10 illustrates another example method for creating a logical resource; and

FIG. 11 illustrates an example method for deleting a logical resource.

### DETAILED DESCRIPTION OF EXAMPLE EMBODIMENTS

### 1. Overview

In one embodiment, a system can map each of the abstraction layer slots to a virtual context of a logical resource, where each virtual context is hosted by a virtual machine from a pool of virtual machines. The system can then identify an available abstraction layer slot from the abstraction layer slots, and reserve the available abstraction layer slot so that a corresponding virtual context of the logical resource can be served. Next, the system can mark the available abstraction layer slot as unavailable.

### 2. Detailed Description

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

In light of the problems identified above with regards to the instantiation of service VMs, what is needed is a method to reduce resource creation time when VMs are used to implement the logical network resources. The subject technology addresses the foregoing need by maintaining a stand-by pool of pre-created service VDTs that are running idle or sleeping after creation. In other words, the various embodiments set forth herein may reduce or eliminate the wait times involved in (a) selecting the host machine, (b) creating VM assets, (c) copying a boot image, and/or (d) loading the boot image. The service VMs host various logical network resources, which can then be allocated and offered by a cloud system management (CSM) system whenever a tenant requests one. This not only allows the CSM to offer the logical resources at a significantly reduced instantiation time, it makes such instantiation time more predictable and uniform.

The process can be further streamlined by introducing an abstraction layer that sits between the logical resources and the backend resources (i.e., VMs) in the form of virtual “slots.” Since a given VM can host more than one virtual context of a logical resource, the individual virtual contexts on the VM can be mapped to different slots. Alternatively, if the VM has only one virtual context, the entire VM can be mapped to a single slot. Since the abstraction layer reduces the level of granularity associated with interfacing with VMs, it helps to simplify the task of the CSM and reduce the possibility of introducing errors when managing the pool of VMs.

In addition, the CSM can maintain the service VM pool at its optimal size by keeping track of the number of free slots. For instance, if a desired set of free slots is S, where S>0, then the desired range DR of free slots can be expressed as DR=INT([f₁(S, . . . ), f₂(S, . . . )]), wherein f₁ and f₂ are functions that determine the lower and upper boundaries of the desired range. When the number of free slots is found to be out of the desired range, the CSM may decide to spin up additional service VMs or destroy excess ones to keep the size of the pool from becoming too small or too large. The CSM can perform such maintenance operations in response to various conditions, such as when a tenant requests a new resource, when a tenant relinquishes a resource, and/or on a periodic basis regardless of resource requests.

A computer network is a geographically distributed collection of nodes interconnected by communication links and segments for transporting data between end nodes, such as personal computers and workstations. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links.

The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Cloud computing can be generally defined as Internet-based computing in which computing resources are dynamically provisioned and allocated to client or user computers or other devices on-demand from a collection of resources available via the network (e.g., “the cloud”). Cloud computing resources, the example, can include any type of resource such as computing, storage, and network devices, virtual machines (VMs), etc. For instance, resources may include service devices (firewalls, deep packet inspectors, traffic monitors, etc.), compute/processing devices (servers, CFU's, memory, brute force processing capability), storage devices (e.g., network attached storages, storage area network devices), etc., and may be used for instantiation of Virtual Machines (VM), databases, applications (Apps), etc.

Cloud computing resources may include a “private cloud,” a “public cloud,” and/or a “hybrid cloud.” A “hybrid cloud” is a cloud infrastructure composed of two or more clouds that inter-operate or federate through technology. In essence, a hybrid cloud is an interaction between private and public clouds where a private cloud joins a public cloud and utilizes public cloud resources in a secure and scalable way.

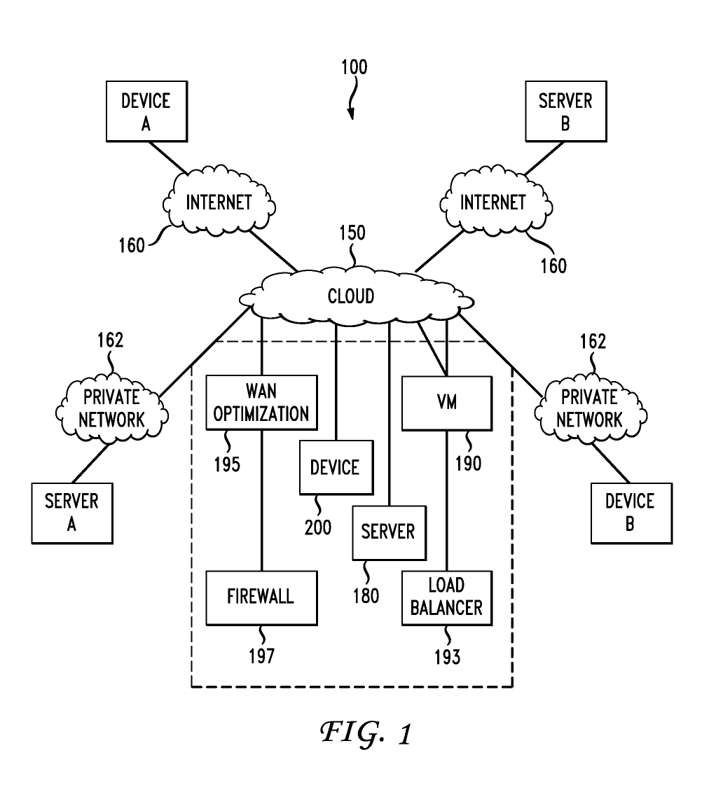

FIG. 1 is a schematic block diagram of an example computer network 100 illustratively including nodes/devices interconnected by various methods of communication. For instance, links may be wired links or shared media (e.g., wireless links, etc.) where certain nodes may be in communication with other nodes based on physical connection, or else based on distance, signal strength, current operational status, location, etc. Those skilled in the art will understand that any number of nodes, devices, links, etc. may be used in the computer network, and that the view shown herein is for simplicity.

Specifically, devices “A” and “B” may comprise any device with processing and/or storage capability, such as personal computers, mobile phones (e.g., smartphones), gaming systems, portable personal computers (e.g., laptops, tablets, etc.), set-top boxes, televisions, vehicles, etc., and may communicate with the network 160 (internet or private networks) to cloud 150. In addition, one or more servers (Server A and B), network management servers (NMSs), control centers, etc., may also be interconnected with (or located within) the network 160 to cloud 150.

Cloud 150 may be a public, private, and/or hybrid cloud system. Cloud 150 includes a plurality of resources such as Firewalls 197, Load Balancers 193, WAN optimization platform(s) 195, device(s) 200, server(s) 180, and virtual machine(s) (VMs) 190. The cloud resource may be a combination of physical and virtual resources. The cloud resources are provisioned based on requests from one or more clients. Clients may be one or more devices, for example device A and/or B, or one or more servers, for example server A and/or B.

Data packets (e.g., traffic and/or messages) may be exchanged among the nodes/devices of the computer network 100 using predefined network communication protocols such as certain known wired protocols, wireless protocols or other protocols where appropriate. In this context, a protocol consists of a set of rules defining how the nodes interact with each other.

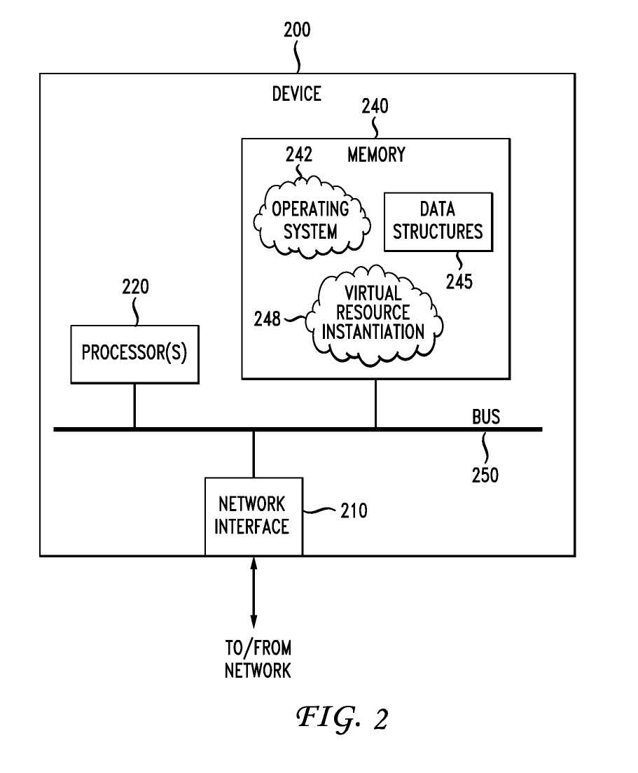

FIG. 2 is a schematic block diagram of an example simplified computing device 200 that may be used with one or more embodiments described herein, e.g., as a server 180, or as a representation of one or more devices as VM 190. The illustrative “device” 200 may comprise one or more network interfaces 210, at least one processor 220, and a memory 240 interconnected by a system bus 250. Network interface(s) 210 contain the mechanical, electrical, and signaling circuitry for communicating data over links coupled to network 100. The network interfaces 210 may be configured to transmit and/or receive data using a variety of different communication protocols, as will be understood by those skilled in the art. The memory 240 comprises a plurality of storage locations that are addressable by processor 220 for storing software programs and data structures associated with the embodiments described herein. The processor 220 may comprise necessary elements or logic adapted to execute the software programs and manipulate data structures 245. An operating system 242, portions of which are typically resident in memory 240 and executed by the processor, functionally organizes the device by, inter alia, invoking operations in support of software processes and/or services executing on the device. These software processes and/or services may comprise an illustrative “virtual resource instantiation” process 248, as described herein.

It will be apparent to those skilled in the art that other processor and memory types, including various computer-readable media, may be used to store and execute program instructions pertaining to the techniques described herein. In addition, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes. For example, processor 220 can include one or more programmable processors, e.g., microprocessors or microcontrollers, or fixed-logic processors. In the case of a programmable processor, any associated memory, e.g., memory 240, may be any type of tangible processor readable memory, e.g., random access, read-only, etc., that is encoded with or stores instructions that can implement program modules, e.g., a module having resource allocation process encoded thereon.

Processor 220 can also include a fixed-logic processing device, such as an application specific integrated circuit (ASIC) or a digital signal processor that is configured with firmware comprised of instructions or logic that can cause the processor to perform the functions described herein. Thus, program modules may be encoded in one or more tangible computer readable storage media for execution, such as with fixed logic or program able logic, e.g., software/computer instructions executed by a processor, and any processor may be a programmable processor, programmable digital logic, e.g., field programmable gate array, or an ASIC that comprises fixed digital logic, or a combination thereof. In general, any process logic may be embodied in a processor or computer readable medium that is encoded with instructions for execution by the processor that, when executed by the processor, are operable to cause the processor to perform the functions described herein.

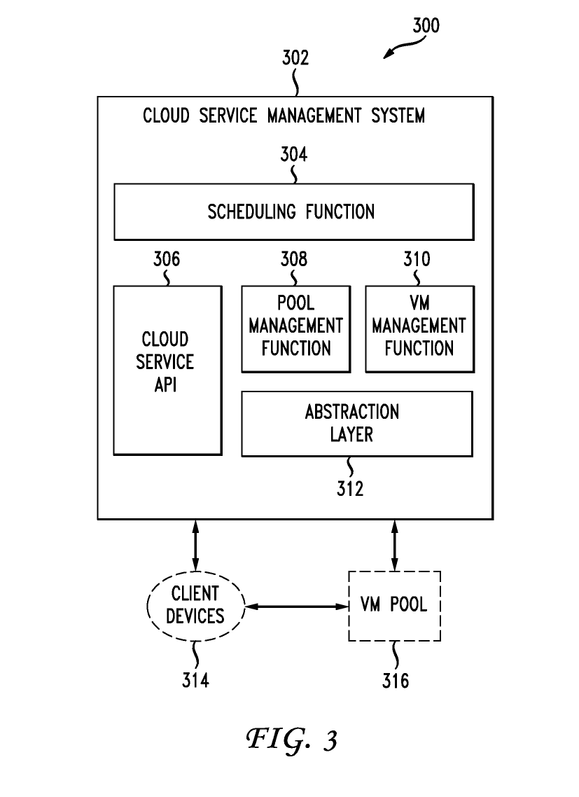

FIG. 3 illustrates an example of a cloud service management (CSM) system. The example CSM system 302 can manage and serve logical resources hosted by VMs in the VM pool 316 to any of the client devices 314. In that regard, CSM system 302 can instantiate and destroy various logical resources according to the current and future needs of client devices 314.

CSM system 302 may consist of several subcomponents such as a scheduling function 304, a cloud service application programming interface (API) 306, a pool management (PM) function 308, a VM management (VMM) function 310, and an abstraction layer 312. The various components of CSM system 302 may be implemented as hardware and/or software components. Moreover, although FIG. 3 illustrates one example configuration of the various components of CSM system 302, those of skill in the art will understand that the components can be configured in a number of different ways. For example, PM 308 and VMM 310 can belong in one software module instead of two separate modules. Other modules can be combined or further divided up into more subcomponents.

CSM system 302 may communicate through its network interface (not shown) with various client devices 314, also known as tenants. For example, client devices 314 may request various services from CSM system 302, including requests for one or more logical resources. CSM system 302, in turn, may access and manipulate VM pool 316 and/or the individual VMs that are contained in VM pool 316 to provide any requested service to client devices 314. Under the supervision of the CSM system, client devices 314 may also directly access and utilize some of the VMs contained in VM pool 316 in order to utilize the logical resources that are hosted thereon. Client devices 314 can be servers, terminals, virtual machines, network devices, etc. that are in need of additional cloud resources through CSM system 302.

VM pool 316, also called the service VM pool, is a collection of one or more virtual machines that can host various logical resources. In other words, VM pool 316 can be a “standby” pool of ready (i.e., created and running), idle, or sleeping service VMs. A virtual machine, as its name implies, is a virtualized or emulated computing environment that is implemented chiefly with software, although it often consists of both software and hardware components. Through virtualization technology, one physical computing device, such as a server, can (concurrently) run multiple virtual machines. Each virtual machine may run on a different operating system (OS) than each other and/or the host device. Each VM may have its own context, storage, communications interfaces, etc. A service VM is a virtual machine that may be used for implementing network services in the backend. Depending on the type of network operating system loaded on it, a service VM can provide multiple network services of different types. In this context, a service VM can be invisible to clients/tenants and may not be unavailable for explicit requests by the clients. In addition, service VMs may not be visible among VMs created by the clients, though service VMs can be equipped with virtual ports where other VMs may attach. The number of active VMs VM pool 316 can be dynamically adjusted so that only the minimum or optimal number of VMs may be operational at any given moment, depending on the level of demand by client devices 314. This helps cut down on the energy cost as well as the amount of resources needed to maintain cloud-based infrastructure.

The VMs in VM pool 316 can be created and launched prior to their use so that they can be more quickly deployed when a need arises. For example, when one of the client devices 314 requests from CSM system 300 an instance of a logical resource, such as a virtual router, rather than provisioning a new VM from scratch, CSM system 300 can simply select and assign an instance of the logical resource hosted by one of the VMs in VM pool 316 for faster deployment.

The individual and/or collective VMs belonging to VM pool 316 can form a backend infrastructure for hosting and providing various cloud services including logical resources. In other words, a logical resource can be implemented at the cloud provider backend by means of a service VM. A logical resource is a software-based resource that behaves much like its hardware counterpart. A logical resource can be a virtual network resource. For example, a virtual router hosted by a service VM would have a similar interface as well as its associated behaviors as a physical router. From the standpoint of a client device that interacts with a resource, there might be only negligible differences between using a logical resource and using a physical resource. Types of logical resources may include, but are not limited to, a firewall, a router, a virtual private network (VPN), a load balancer, a WAN optimizer, a deep packet inspector, a traffic monitor, etc.

A single service VM can host more than one instance of a logical resource. That is, the VM may have one or more virtual contexts for a given logical resource that operate independently from one another. The virtual contexts can be independent of the global context of the VM. For example, a VM router may have eight separate virtual contexts, each with its own set of environmental variables, states, configurations, user preferences, etc. Another example of a virtual context is virtual routing and forwarding (VRF). Each virtual context may be assigned to a different client device. In some instances, more than one virtual context can be assigned to the same client device. Although the virtual contexts that reside in the same VM may share the same hardware resources of the VM, such as the processors, memory, bus, storage, etc., from the perspective of the individual client devices 314, each virtual context essentially functions like a separate physical resource. Thus, for example, a VM firewall with 128 virtual contexts can be logically equivalent to having 128 physical firewall devices.

Moreover, one service VM may host more than one type of logical resource, each of the logical resources potentially having more than one virtual context. For example, it would be possible for a single virtual machine to host four virtual contexts for a virtual router and six virtual contexts for a virtual load balancer. Thus, logical resources are not necessarily mapped to the VMs on a one-to-one basis. Furthermore, a VM hosting one type of logical resource can be reprovisioned to host a different type of logical resource. For example, if CSM system 302 determines that the demands of client devices 314 are such that more virtual routers, but less virtual firewalls are needed, then CSM system 302 can decommission some of the VMs in VM pool 316 that were providing the firewall service and repurpose those VMs to host instances of the virtual router.

Client devices 314 may communicate with CSM system 302 through cloud service API 306. The tenant-facing cloud service API 306 may consist of various functions, routines, methods, etc. that are made available to each of client devices 314 to request service, transmit/receive data, manipulate resources, etc. For example, a client device can use cloud service API 306 to request a logical resource from CSM system 302, cancel the request, relinquish the resource, etc. Thus, cloud service API 306 plays an important role in the workflow that involves maintenance of VM pool 316 and allocation of the VMs.

Abstraction layer 312 may be situated between the logical resources and the backend resources (namely the VMs that implement the logical resources). Abstraction layer 312 can be implemented with software, hardware, or a combination of both. Although FIG. 3 shows abstraction layer 312 as being part of CSM 302, abstraction layer 312 may be located outside CSM system 302. For example, abstraction layer 312 can be part of VM pool 316 or an individual VM inside VM pool 316. The abstraction layer may have its own set of API commands that CSM 302 can use to interface with the service VMs VM pool 316. Abstraction layer 312 allows CSM 302 to utilize the resources provided by a VM more efficiently because the level of granularity offered by a typical VM can be quite high without such an extra layer of abstraction. In other words, by hiding some of the technical details of the VMs in VM pool 316, abstraction layer 312 allows CSM 302 to manage VM pool 316 more efficiently.

The way that abstraction layer 312 hides those details for CSM system 302 cat be through the use of virtual “slots.” A slot, similar to physical slots found in data networking equipment, is a symbolic and logical metaphor that can be used to manage various aspects of the logical resources hosted by the VMs. Each slot can be mapped to a logical resource. Alternatively, when applicable, the slot can be mapped to a virtual context inside a VM. The slot can also be mapped to an entire VM itself, especially when the VM has only one virtual context. CSM system 302 may use this virtual slot metaphor to assign slots, which are mapped to logical resources, to client devices whereby the client devices can have exclusive access to the mapped resources.

A slot is free or available when it is mapped to a logical resource or a virtual context of a logical resource, but is not assigned to a client device. In other words, once CSM 302 assigns a slot to a client device, that slot becomes unavailable and no other device may use that particular logical resource or its virtual context until the slot becomes available again. For example, when a particular service VM is up and running, it may provide X free slots, where X is the number of the maximum virtual contexts that the VM can host. If VM can host 32 virtual contexts, then X=32. On the other hand, if the entire VM is mapped to a single slot, then X=1. Then, when a logical resource mapped to one of the slots is assigned to a client device, the VM is left with X−1 free slots. Subsequently when the slot becomes available again (e.g., because the client device no longer requires it), the VM will once again have X available slots. Individual slots can be given serial numbers or names for identification purposes.

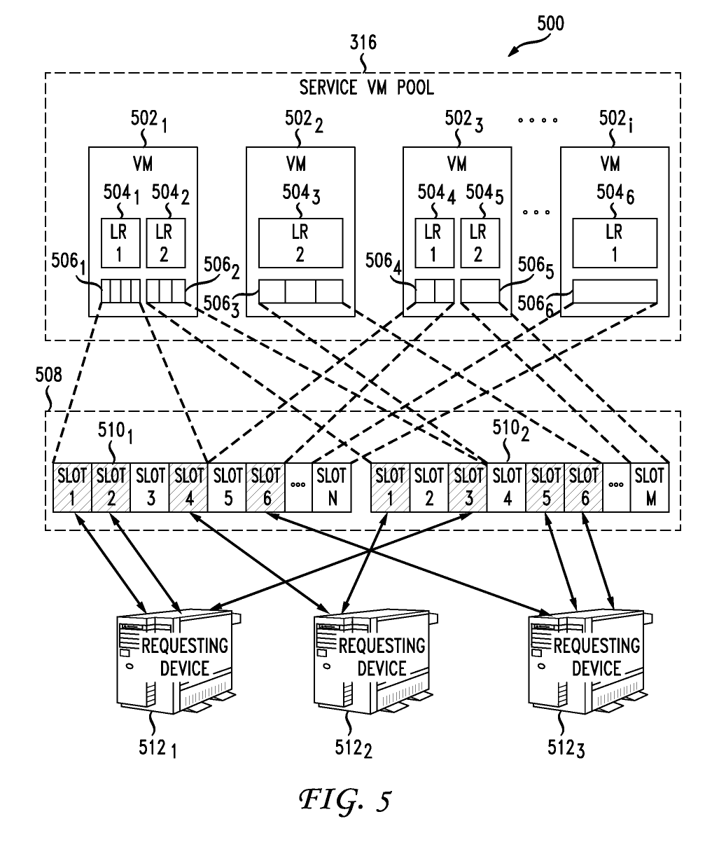

Moreover, CSM 304 can have more than one set of slots, or alternatively more than one set of abstraction layers, to separately keep track of different types of logical resources. For example, CSM system 304 can have one abstraction layer with a set of slots for managing all the virtual routers in VM pool 316, and have a separate abstraction layer with its own set of slots for managing virtual firewalls. The multiple abstraction layers or sets of slots can be arranged hierarchically. For example, the virtual router VMs in VM pool 316 can have their own sets of slots and CSM 302 can maintain a higher-level abstraction layer that consolidates the individual sets of slots, as illustrated in FIG. 5. p The scheduling function (SCH) 304 may be mainly responsible for managing the virtual slots in abstraction layer 312. Specifically, SCH 304 can map various service VMs, logical resources, and virtual contexts to the slots and assign some of those slots when client devices 314 request service via cloud service API 306. When CSM system 302 receives a new service request from a client device, SCH 304 selects a free slot (and thereby a VM responsible for that slot) in order to provide the requested logical resource. SCH 304 may try to maintain a desired set of free slots S in abstraction layer 312, which translates to a desired number of available resources in VM pool 316, where the size S>0.

SCH 304 may try to keep the actual number of free slots S_{A} within the desired range DR. For example, the desired range DR can be represented by the formula, DR=INT[f₁(S, . . . ), S, . . . )], where f₁ and f₂ are functions of S and any other relevant parameters that determine the lower bound and the upper bound for the desired range, such that 0<f₁(S, . . . )≦f₂(S, . . . ). The other parameters can be, for example, number of client devices 314 currently being serviced by CSM 302, projected service demands from client devices 314, number of service requests, resource request rate, time, current size of VM pool 316, maximum capacity of VM pool 316, average provisioning time (i.e., boot time) for VMs, proportions among the types of logical resources requested, etc.

These various parameters can be factored into the determination of the ideal number of available resources and other margins. In one aspect, upper and lower bounds may be defined by functions f₁=S−M and f₂=S+M, where M is a configurable margin. Other more sophisticated formulas can be employed to determine the more desirable margins. In one embodiment, VM pool 316 can be populated with its desired size S when CSM 302 is being initialized, however, once the number of actual free slots S_{A} falls outside the desired range DR (e.g., in the course of receiving various requests from and providing service to client devices 314), CSM 302 may add more free slots by provisioning more VMs or remove excess free slots by removing VMs from VM pool 316.

Optionally, SCH 304 may have a deficit flag (not shown) that can be “raised” to signify that the number of available slots has dropped below the desired range and that the slots need to be adjusted accordingly. In one embodiment, the deficit flag is connected to a physical sensor or an input device that keeps track of the number of available slots. In another embodiment, the deficit flag is implemented with software. In yet another embodiment, the deficit flag consists of both hardware and software components. A flag can be a Boolean variable. SCH 304 can have more than one deficit flag to keep track of different sets of virtual slots. SCH 304 may also rely on other types of logical flags to signal to the other components of CSM system 302, such as PM 308 and VMM 310, about various states of scheduling function 304 and/or abstraction layer 312. For example, SCH 304 may use a flag o indicate that VM pool 316 has too many running VMs. Once the issue that is related to the raised flag is resolved, the flag can be “lowered” by SCH 304 or other components of CSM system 302.

Once the number of free slots falls outside the desired range, the pool management function (PM) 308 may add or remove instances to a standby service VM pool 316, which tries to maintain around S free slots ready for deployment. The instructions to add or remove free slots may be issued by SCH 304. In another embodiment, PM 308 may detect that a deficit flag or any other flag is raised and then determine for itself that the number of free slots may need adjustment. PM function 308 can operate statically (i.e., run only a fixed number of times or run on a predetermined schedule) or it can operate dynamically (i.e., run continuously or whenever a need rises). For this purpose, PM function 308 can take inputs such as, for example, a resource request rate.

Preferably, PM function 308 can run whenever there is a request from a client device 314. For example, after assigning a slot to the client device 314 or freeing a slot, PM 308 can run its maintenance routines to ensure that the size of the VM pool stays within the desired boundaries. The maintenance can be performed when logical resources are created or deleted. It can also be performed periodically. Hence, the scheduling of logical resources and the pool management need not be tightly coupled. Moreover, PM 308 can take into account inputs, parameters, and measurements such as resource request rate, and increase or decrease the size of VM pool 316 in the background, with an aim to keep enough logical resources available to any tenant device that may request them.

The virtual machine management function (VMM) 310 can be called upon by PM 308 or other components of CSM system 302 to create and delete service VMs. VMM 310 is capable of directly interfacing with the individual VMs in VM pool 316 in order to create, configure, provision, manipulate, and delete VMs. VMM 310 can boot up, set up, and install applications to VMs as well as power them off. In that regard, the operations of VMM 310 are closely related to abstraction layer 312. Alternatively, VMM 310 can be part of abstraction layer 312 that hides granular details about the VMs' operations.

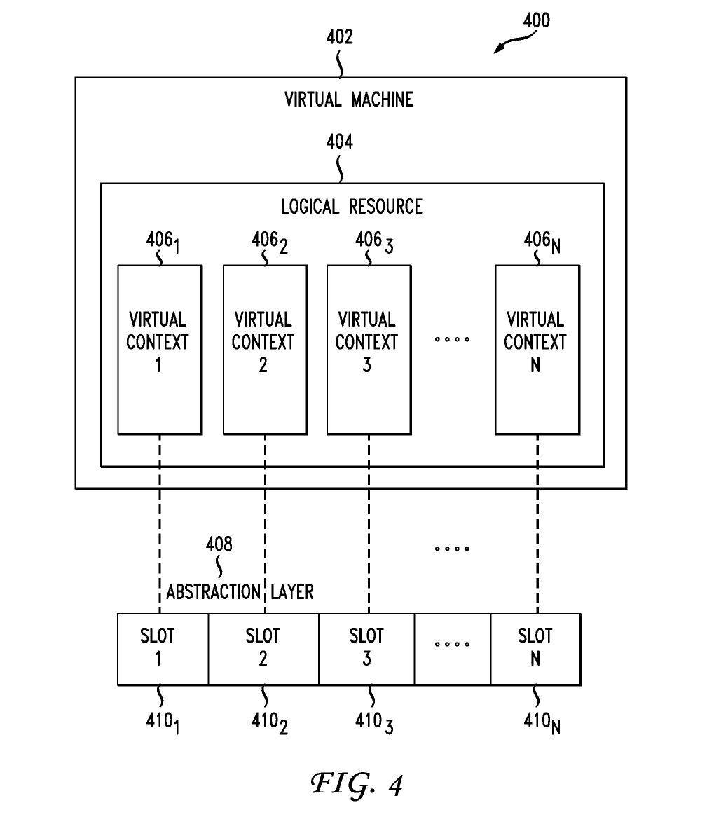

FIG. 4 is a block diagram illustrating an example system 400 featuring a virtual machine 402 mapped to an abstraction layer 408. VM 402 can be part of VM Pool 316 as shown in FIG. 3. In one embodiment, abstraction layer 408 is part of CSM system 302. In another embodiment, abstraction layer 408 is managed by virtual machine 402 itself. Abstraction layer 408 can be purely software-based. Virtual machine 402 may be configured to host one or more logical resources 404 (only one logical resource is shown). Logical resource 404 can be a virtual network resource such as a firewall, a router, a virtual private network (VPN), a load balancer, a wide area network (WAN) optimizer, a deep packet inspector, a traffic monitor, etc.

Each logical resource 404 can have therein one or more virtual contexts 406₁, 406₂, 406₃, . . . , 406_{N} (collectively “406”) that can opera e independently from each other as separate logical resources. Virtual contexts 406 can be mapped the slots 410₁, 410₂, 410₃, . . . , 410_{N} (collectively “410”). As additional virtual contexts or additional virtual machines come online (i.e., finish booting up), they may be also added to abstraction layer 408 as extra slots. Although FIG. 4 shows abstraction layer 408 as having the same number of slots 410 as the number of virtual contexts 406, those skilled in the art will understand that the number of virtual slots 410 can be higher or lower than the number of virtual contexts 406, in which case excess virtual contexts or slots would exist.

Once mapped to the slots, virtual contexts 406 or logical resources 404 can be assigned to tenants 314. By examining the status of slots 410 being occupied or assigned, CSM system 302 can determine which logical resources or virtual contexts are available for use and how many. For example in FIG. 4, if slot 410₁ and slot 410₃ (and by extension virtual context 406₁ and virtual context 406₃) are assigned to some of client devices 314, CSM system 302 can determine that the number of free slots (and thus the number of available resources) is N−2.

FIG. 5 is a block diagram illustrating another example system 500 featuring service VM pool 316, abstraction layer 508, and client devices 512₁, 512₂, 512₃ (collectively “512”). The CSM system (not shown) may also be involved in mapping logical resources 504₁, 504₂, . . . , 504₆ (collectively “504”) to abstraction layer 508 and subsequently assigning slots 510₁, 510₂ to the requesting devices 512. Service VM pool 316 can be a collection of one or more service VMs 502₁, 502₂, . . . , 502ᵢ (collectively “502”). VMs 502 can host various types of logical resources 504 on them. Client devices 512 may request access to one or more of logical resources 504 through CSM system 302. CSM system 302 can then assign free slots to each of the requesting client devices 512.

VMs 502 may host one or more types of logical resources 504. For example, logical resources 504₁, 504₄, 504₆ can be of type 1 and logical resources 504₂, 504₃, 504₅ can be of type 2. As a further illustration, the type 1 logical resource can be a virtual firewall and the type 2 logical resource can be a VPN. As shown in FIG. 5, virtual machine 502₂ may host only one type of logical resource 504₃, and virtual machine 502₁ may host two or more types of logical resources 504₁, 504₂. Each VM 502 may also host multiple instances of a given logical resources. For example, VM 502₁ can run four virtual contexts for logical resource 1 (504₁) and three virtual contexts for logical resource 2 (504₂), while VM 502₂ can have three virtual contexts for logical resource 2 (504₃) but no virtual contexts for logical resource 1.

The abstraction layers 506₁, 506₂, . . . , 506₆ (collectively “506”) may feature virtual slots that are mapped to virtual contexts in VMs 502. Although abstraction layers 506 are depicted in FIG. 5 as being part of VMs 502, abstraction layers 506 do not necessarily have to reside inside any VM. The software implementation and/or the logical data structure of abstraction layers 506 can be stored inside VMs 502, CSM system 302, or any other computing device. Each VM 502 can have its own set of slots 506 for its logical resources 504. For example, VM 502₁ can have four slots in abstraction layer 506₁ mapped to the four virtual contexts of logical resource 1 (504₁) and three slots in abstraction layer 506₂ mapped to the three virtual contexts of logical resource 2 (504₂). In another example, VM 502ᵢ may have only one slot in abstraction layer 506₆, mapped to its only logical resource 504₆.

Optionally, CSM system 302 may aggregate virtual slots 506 of multiple VMs 502 and arrange them into another layer of abstraction layer 508. Abstraction layer 508 can be a separate layer from abstraction layers 506 arranged in a hierarchical fashion. Alternatively, abstraction layer 508 can simply be a collection and/or rearrangement of the information that pertains to abstraction layers 506. For example, the four slots in abstraction layer 506₁, the two slots in abstraction layer 506₄, and the one virtual slot in abstraction layer 506₆ for logical resource 1 can be rearranged and renumbered as slots 1-7 in abstraction layer 510₁. That way, CSM system 302 can manage every instance of the same resource type (i.e., logical resource 1) with a single set of virtual slots 510₁. Similarly, virtual contexts for logical resource 2, which are spread across multiple VMs 502, can be mapped to one master set of slots 510₂.

In one embodiment, CSM system 302 may maintain separate abstraction layers (i.e., separate sets of virtual slots) for different logical resource types. For example, CSM system 302 can map all the virtual contexts for virtual router to one set of slots numbered 0-1023 and all the virtual contexts for virtual firewall to another set of slots numbered 0-511, similar to what is shown in FIG. 5. In another embodiment, CSM system 302 can have one big set of virtual slots that combine two or more types of logical resources. For example, CSM system 302 can map every instance of virtual router or virtual firewall to one set of slots numbered 0-1535.

When tenant devices 512 request access one or more logical resources, CSM 302 can look up the current status of abstraction layer 508 and determine whether an instance of the requested resource type is available for assignment. Specifically, by examining whether a given slot in abstraction layer 508 is already occupied (shown in FIG. 5 as shaded), CSM 302 can determine whether that slot is available for assignment. For example, slots 1 and 2 for logical resource type 1 are currently assigned to requesting device 512₁, while slots 4 and 6 are assigned to requesting device 512₂ and requesting device 512₃, respectively. Likewise, slot 1 for logical resource type 2 is assigned to requesting device 512₂, slot 3 is assigned to requesting device 512₁, and slots 5 and 6 are assigned to requesting device 512₃.

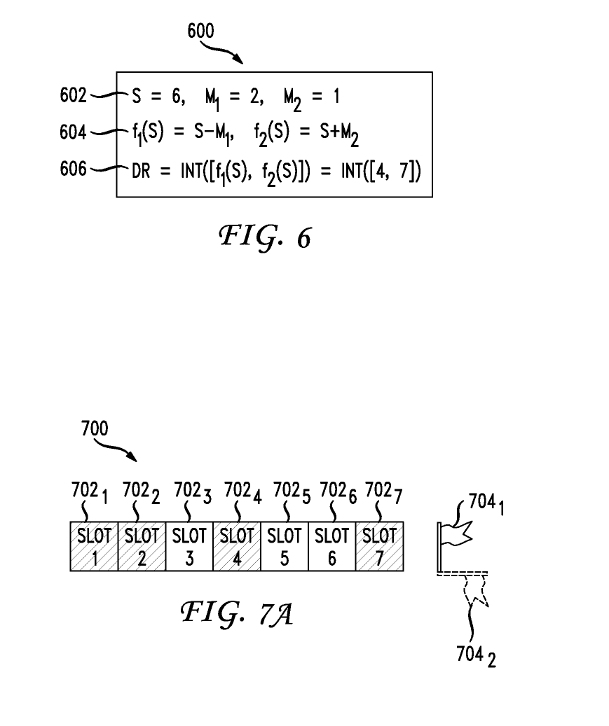

FIG. 6 illustrates an example of a desired range for the number of available resources. In order to achieve the optimal performance and minimal wait time between resource request and resource availability in VM pool 316, PM 308 may have a predetermined value S 602 for the desired number available slots in abstraction layer 508, which may also correspond to the number of available, or unused, resources in VM pool 316. In other words, the value S 602 can be the ideal or target number of free slots, as estimated by CSM 302, that PM 308 strives to maintain in abstraction layer 508. Having a number of spare VMs (and thereby a few extra logical resources) running in VM pool 316 makes it possible for CSM system 302 to provide service to a tenant at a moment's notice. At the same time, having too many underutilized VMs in VM pool 316 can be costly and wasteful.

Thus, the value S 602 can be calculated with a mathematical formula based on a number of different variables including the number of client devices 314, projected service demands, number of pending service requests, resource request rate, calendrical time (e.g., time of day, day of week, holiday, etc.), VM pool size, VM pool capacity, VM provisioning time (i.e., boot time), VM failure rate, etc. The value S 602 may change dynamically as some of those dependent variables change over time. For example, as the service request a e from client devices 314 increases, the desired number of free slots S 602 may also increase to compensate for the increased demands. In another example, during a downtime, such as in the middle of the night, the value S 602 can be adjusted in order to decrease the number of free slots, When the number of available resources in VM pool 316 falls below the value S 602, CSM 302 can spin up one or more additional VMs to meet the target number of resources. On the other hand, when the number of free resources exceeds the target value S 602, some of the excess resources can be destroyed.

Alternatively, CSM 302 can have a desired range DS 606 for the number of available logical resources. In other words, CSM system 302, or its PM subcomponent 308, would try to keep the number of free slots within the desired range DS 606, and when the number of free slots gets out of the lower and upper bounds of range DS 606, the number of service VMs or instances of logical resource can be adjusted accordingly. DS 606 can be determined based on the value S 602 for the desired number of free slots. For example, DR 606 can be expressed as INT([f₁(S), f₂(S)]), where INT([ ]) represents an interval with inclusive lower and upper bounds, and where f₁(S) and f₂(S) are functions of S representing the lower and upper bounds, respectively. However, those of skill in the art will understand that desired range DR 606 can be determined by a different formula.

In some implementations, the functions f₁(S) and f₂(S) can be dependent upon other variables as well, such as the number of client devices 314, projected service demands, number of pending service requests, resource request rate, first derivative of the resource request rate, second derivative of the resource request rate, average resource usage time, predicted resource release time, calendrical time, VM pool size, VM pool capacity, VM provisioning time, VM failure rate, etc.

As an example, the lower bound and the upper bound of desired range DR 606 can be represented by the functions f₁(S) and f₂(S) such that f₁(S)=S−M₁ and f₂(S)=S+M₂, where M₁ and M₂ are non-negative integers representing the lower and upper margins. In this example, S=6, M₁=2, and M₂=1 (602), which makes desired range DR 606 equal to INT([4, 7]). In other words, CSM 302 will try to keep the number of free slots (and therefore the number of available resources) between 4 and 7, and create or destroy VMs when necessary to meet the VM pool size requirement.

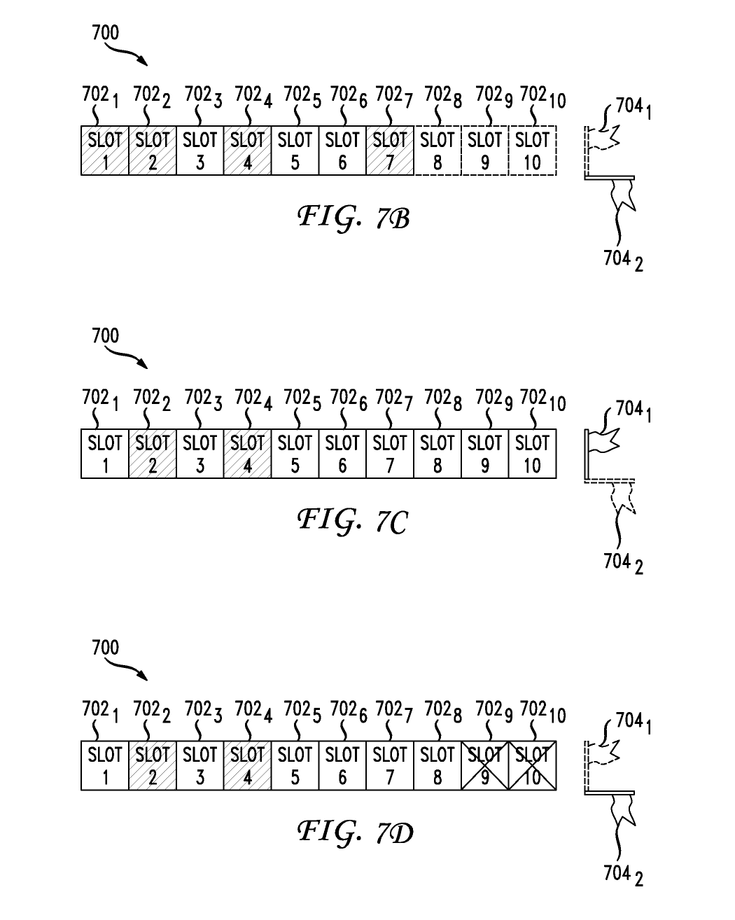

FIGS. 7A-7D are block diagrams illustrating an example scheduling function operation for the VM pool. Abstraction layer 700 features a set of virtual slots (collectively “702”) that may be mapped to logical resources hosted by service VMs 502 in service VM pool 316. The slots that are assigned to client devices 314 are shown in the figures as shaded. Conversely, the unshaded slots represent free slots that can be assigned to a new client. Flag 704, when raised 704₁, may signify that the number of free slots has fallen outside desired range DR 606, and that the number of available slots needs to be readjusted by either creating additional VMs or destroying excess VMs. Raising or lowering flag 704 can be accomplished, for instance, by switching a binary flag bit between 0 (i.e., “lowered” position 704₂) and 1 (i.e., “raised” position 704₁). In one embodiment, there can be more than one flag. For example, deficit flag can be used exclusively to signal that the number of free slots has fallen below DR 606, and another flag can be used exclusively to signal that the number of free slots has exceeded the desired range DR. Both abstraction layer 700 and the flag can be implemented entirety with software or as a combination of both hardware and software.

Abstraction layer 700 may contain other information pertaining to the management of VM pool 316. For example, each slot may contain information about the identity of the VM that it is mapped to, identity of the mapped virtual context, time of mapping, assignment status (e.g., tenant identifier, assignment time, scheduled release time, etc.), whether the slot can be shared by more than one device, reservation queue, etc. Scheduling and assignment of virtual slots to clients 314 can be handled by SCH 304, while PM 308 and VMM 310 may adjust the pool size and create/destroy VMs, respectively.

In FIG. 7A, abstraction layer 700 currently has seven slots 702₁, 702₂, . . . , 702₇, each slot mapped to a logical resource or a virtual context of a logical resource. In other words, the seven slots 702 represent seven separate instances of a logical resource, which, in turn, can be equivalents of seven physical resources. The logical resources mapped to slots 702 may be hosted by one service virtual machine or spread across multiple service virtual machines in VM pool 316. However, from the viewpoint of SCH 304, some of those details may be hidden. Presently, four of the seven virtual slots, namely slots 702₁, 702₂, 702₄, 702₇ are assigned to one or more client devices 314. Thus, abstraction layer 700 currently has three free slots 702₃, 702₅, 702₆. During one of its periodic maintenance routines, PM 308 may discover that the number of free slots (i.e., S_{A}=3) has fallen below the lower bound of the desired range DR=INT([4, 7]) 606. PM 308 may alert other components of CSM system 302 by raising flag 704 to its raised position 704₁. Raised flag 704₁ may indicate that the request rate is on the rise.

In FIG. 7B, VMM 310 may detect that flag 704 has been set to its raised position 704₁ and determine that either VM pool 316 needs extra VMs or the existing VMs need to run more instances (i.e., virtual contexts) of the logical resource. VMM 310 proceeds to instantiate three more instances of the logical resource by, for example, booting up one or more extra service VMs. Although the number 3 has been chosen in this example for the number of extra resources to produce in order to bring the total number of available slots to coincide with the value of the desired number of available slots S=6 (602), those of skill in the art will appreciate that more slots or fewer slots can be created as long as the resulting number of available slots would fall within the desired range DR=INT([4, 7]). For example, VMM 310 can produce only the bare minimum number of new resources (i.e., one new slot) to bring the number of free slots in conformity with the desired range DR. After VMM 310 finishes its job, flag 704 can be set to its lowered position 704₂ to prevent any duplicate resource creation operations in the future. When the newly created resources become online and accessible, PM 308 can create new virtual slots 702₈, 702₉, 703₁₀ and map them to the three newly available instances of the logical resource. Accordingly, the free slot count S_{A} may now be adjusted from 3 to 6.

In FIG. 7C, some of client devices 314 have terminated service with CSM system 302. Consequently, the slots 702₁, 702₇, which have been previously assigned to one or more client devices 314, are released by scheduling function 304 and become available for future assignments. The available slot count S_{A}, therefore, further increases by 2 to become 8. PM 308, during one of its routing maintenance sessions, may detect that the free slot count is too high, which may result in inefficiency and waste of resources in VM pool 316. PM 308 can raise flag 704₁ to alert VMM 310.

In FIG. 7D, VMM 310 detects that flag 704₁ has been raised and proceeds to power down some of the VMs in order to reduce the number of idle resources. In this example, VMM 310 pulls the plug on the logical resources or virtual contexts that are mapped to slots 702₉, 702₁₀. The two slots 702₉, 702₁₀ are also removed from abstraction layer 700 on that they can no longer be assigned to clients. CSM 302 may also decrease the available slot count by 2 on that S_{A}=6, and set flag 704 to its lowered position 704₂. Although the number 2 is chosen in this example so that the resulting free slot count would be equal to the value of the desired number of free slots (i.e., S_{A}=S=6), any number of slots may be deleted as long as the resulting free slot count falls within the desired range DR. Once all the maintenance operation is finished, flag 704 can be set to its lowered position 704₂ to signal that no further slot count adjustments need to be made at the moment.

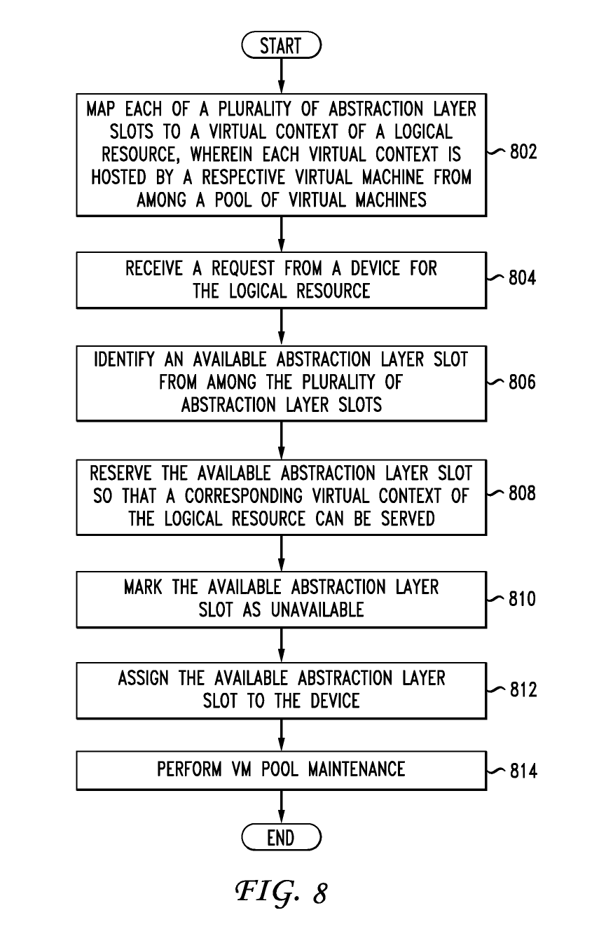

Having disclosed some basic system components and concepts, the disclosure now turns to some exemplary method embodiments shown in FIGS. 8-11. For the sake of clarity, the methods are discussed in terms of an example system 100, as shown in FIG. 1, configured to practice the methods. It is understood that the steps outlined herein are provided for the purpose of illustrating certain embodiments of the subject technology, but that other combinations thereof, including combinations that exclude, add, or modify certain steps, may be used.

FIG. 8 illustrates an example method for creating, or instantiating, a logical resource. In practice, system 100 can map each of a plurality of abstraction layer slots to a virtual context of a logical resource, wherein each virtual context is hosted by a respective virtual machine from among a pool of virtual machines (802). The plurality of abstraction layer slots may be a software-based data structure that is stored in a cloud service management system or a virtual machine. In one embodiment, the abstraction layer slots can be mapped to virtual contexts of more than one type of logical resource. The logical resource can be a virtual network resource such as a firewall, a router, a virtual private network (VPN), a load balancer, or a WAN optimizer. A virtual machine can host more than one logical resource and more than one instance or virtual context of a resource.

System 100 can then receive a request from a device for the logical resource (804). The requesting device can be a client device or a tenant making the request via an API. The request may specify such items as the type of resource needed, priority, duration of use, minimum performance requirements, etc. Resource creation may occur when other logical resource “creation” trigger events occur. System 100 identifies an available abstraction layer slot from among the plurality of abstraction layer slots (806). The identification of the available abstraction layer slot can be accomplished by a scheduling function. Once assigned to a client device, the abstraction layer slot and its associated logical resource may become unavailable to other client devices. Thus, when system 100 identifies an available abstraction layer slot, a logical resource, a virtual context of the logical resource, or a service VM hosting the logical resource that is mapped to the slot may be also identified.

System 100 reserves the available abstraction layer slot so that a corresponding virtual context of the logical resource can be served (808). The reservation of the available abstraction layer slot may mean that the requesting device has exclusive use of the slot and the logical resource (or one of its virtual contexts) that is mapped to that slot. In other words, the slot is no longer available for other devices to access. System 100 then marks the available abstraction layer slot as unavailable (810). As a result, a free slot count for system 100 decreases by one. Marking the slot as unavailable can help avoid assigning any particular abstraction layer slot to multiple requesting devices. In some embodiments, however, one abstraction layer slot may be assigned to two or more requesting devices and the associated logical resource may be shared among the multiple requesting devices.

System 100 assigns the available abstraction layer slot to the device (812). As the result of the assignment, the device can have exclusive access to the logical resource mapped to the abstraction layer slot, which is now marked as being unavailable. The timings for marking the slot unavailable and assigning the slot to the device may be interchangeable. In other words, the slot can be marked unavailable after the slot is assigned to the requesting device. Optionally, system 100 may perform VM pool maintenance (814) in order to keep the size of the VM pool within the desired range of values.

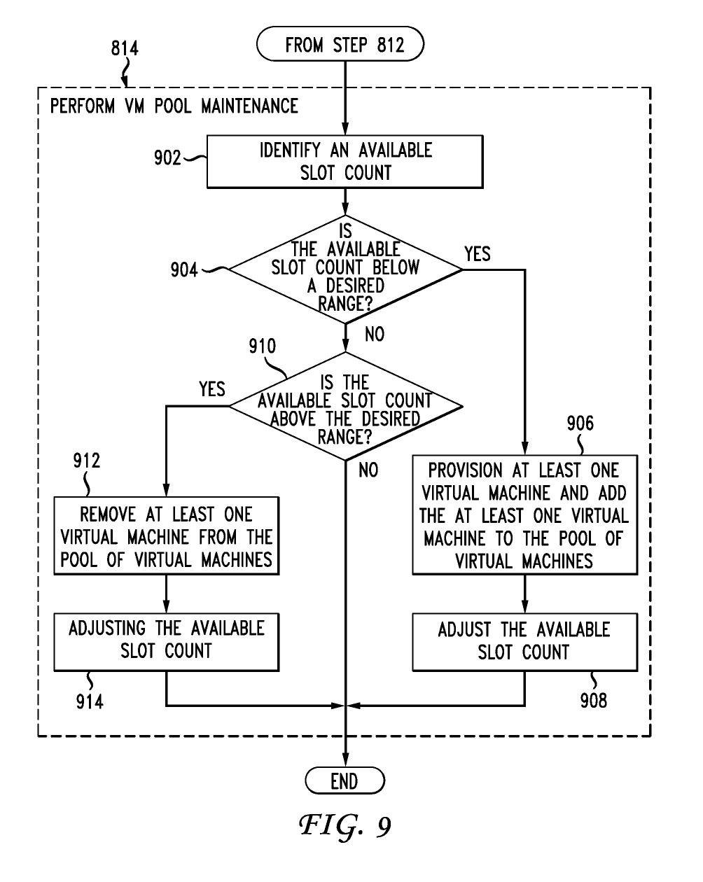

FIG. 9 illustrates an example method for performing VM pool maintenance. The VM pool maintenance can ensure that the number of free slots S_{A} is kept within the bounds of the desired range DR. The VM pool maintenance can be performed when a trigger event is detected such as creation, instantiation, production, removal, or deletion of a logical resource or a service VM. Alternatively, triggering can also occur as a result of some logic internal to system 100. The VM pool maintenance can be also performed periodically or according to a predetermined schedule. The VM pool maintenance can be performed by the scheduling function, the pool manager, or the VM manager of a cloud service management system.

As part of the VM pool maintenance routine, system 100 can identify an available slot count (902). The available slot count generally corresponds to the number of available or free logical resources. System 100 then determines whether the available slot count is outside a desired range. Specifically, system 100 may determine whether the available slot count is below the desired range (904). The desired range is the range of values for the number of free slots that system 100 deems acceptable, ideal, or optimal. The range can be determined based on the desired number of free slots. If the free slot count is indeed below the desired range, then system 100 may create or provision at least one virtual machine and add the new virtual machine to the pool of virtual machines (906). Optionally, a deficit flag (e.g., a Boolean value) can be set to “TRUE,” which may signify that the rate of resource consumption in the VM pool is higher than the rate of return of slots. In other words, the raised flag may signal that the VM pool is running low.

In some embodiments, the creation of a service VM can be triggered by an API call to system 100 by an external entity or a user. In other embodiments, the virtual machine may be prepared as a result of other triggering events. For instance, system 100 may detect that a seasonal peak time is approaching and that more virtual machines are required. The newly created virtual machines may host one or more instances or a logical resource that can be assigned to client devices for use. Once new virtual machines, and thereby new logical resources, are created, system 100 can adjust the available slot count (908) by increasing the slot count by the number of new instances of the resource. During the VM pool maintenance, the desired VM pool size S or the lower and upper bound functions f₁ and f₂ may also be dynamically adjusted based on the various factors mentioned above including projected service demands, number of pending service requests, resource request rate, etc.

System 100 may also determine whether the available slot count is above the desired range (910). If so, then system 100 can remove at least one virtual machine from the pool of virtual machines (912). As a result, any logical resources or instances of the logical resources that were hosted by the removed virtual machine may be also deleted. Alternatively, one or more virtual contexts can be deactivated. The system may then adjust the available slot count (914) by subtracting the number of removed resources from the count. Optionally, more VMs can be provisioned or removed in a recursive manner until the available slot count is within the desired range.

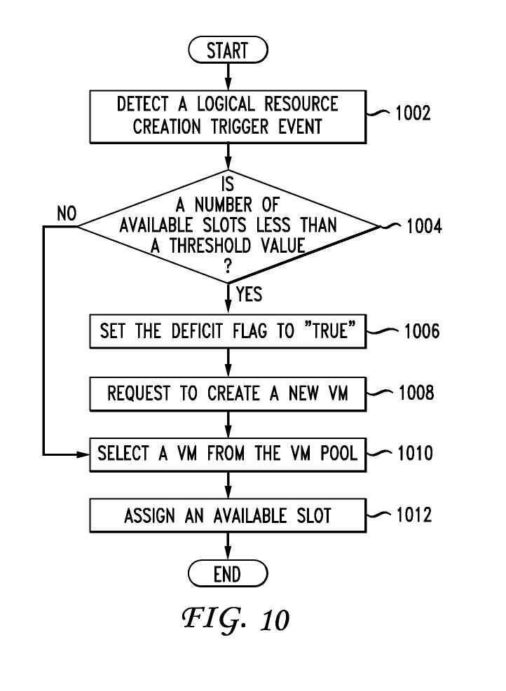

FIG. 10 illustrates another example method for creating a logical resource. System 100 detects a logical resource “creation” trigger event (1002). In some embodiments, the “creation” trigger event can be an API call from a client device requesting a logical resource. In other embodiments, the trigger event can be an anticipation of a demand surge. System 100 may then determine whether a number of available slots is less than a threshold value (1004). This condition may be assessed early on in the creation process so that system 100 can start preparing any necessary new VMs as soon as possible. The threshold value can be an optimal number of free slots in an abstraction layer as estimated by system 100. Alternatively, the threshold value can be a lower bound of a desired range of free slots as estimated by system 100. If there are already enough free slots, and therefore enough resources, the process can skip ahead to the selecting step 1010.

However, if the number of free slots is below the threshold, system 100 can optionally set the value of the deficit flag to “TRUE” (1006). The flag can be a Boolean variable that can have one of two states, “TRUE” and “FALSE.” which can be represented by the binary bits 1 and 0. A component of system 100, such as a VM manager, can detect the flag's “TRUE” status and create a new VM that can host additional logical resources, system 100 can also explicitly request the creation of a new VM (1008). Once created, the new VM can join the ranks of other service VMs in the service VM pool. System 100 may select a VM from the VM pool (1010). Such selection can be accomplished by using an abstraction layer that logically maps the resources hosted by the VMs or the VMs themselves to virtual slots in the abstraction layer. In such case, the system may assign an available slot and/or mark the slot as used so that the resource associated with the slot may not be duplicatively reassigned to other devices (1012).

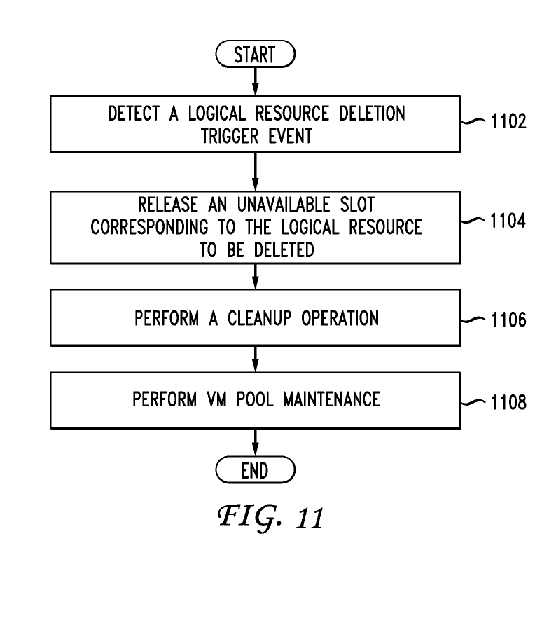

FIG. 11 illustrates an example method for deleting a logical resource and/or releasing a virtual slot. System 100 detects a logical resource “deletion” trigger event (1102). The deletion trigger event can be an API call, periodic VM pool maintenance, expiration of service, etc. For example, a tenant device may explicitly request a release of a logical resource being used, or the service agreement between the tenant and system 100 for the resource may naturally expire. System 100 can release an unavailable or occupied abstraction layer slot that corresponds to the logical resource to be deleted (1104). Thus, the newly released slot can become available for reassignment. System 100 may have to force the resource to disconnect from the client. In the alternative, the corresponding VM can be powered off and the slot may be removed accordingly.

Next, system 100 may perform a cleanup operation (1106). This step can be performed by the scheduling function (SCH) or the pool management (PM) function. As part of the cleanup operation, any old configurations may be cleared and the heretofore unavailable abstraction layer slot can be marked once again as being available. Subsequently, the available slot count may be adjusted accordingly. Optionally, system 100 may perform VM pool maintenance (1208). The VM pool maintenance after resource deletion can be substantially similar to the procedure illustrated in FIG. 9.

It should be understood that the steps shown above are merely examples for illustration, and certain steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for improving user experience, simplifying application service design using cloud services, and more predictably establishing a virtual resource instantiation time.

While there have been shown and described illustrative embodiments ha provide for an accelerated instantiation of a cloud resource provided as a service VM, it is to be understood that various other adaptations and modifications may be made within the spirit and scope of the embodiments herein, For example, the embodiments have been shown and described herein with relation to cloud networks, However, the embodiments in their broader sense are not as limited, and, in fact, may be used with other types of shared networks. Moreover, even though some of the embodiments have been shown and described herein with relation to virtual network resources, other types of resources such as service devices, compute/processing devices, storage devices, etc, may also be hosted as logical resources.

The foregoing description has been directed to specific embodiments. It will be apparent, however, that other variations and modifications may be made to the described embodiments, with the attainment of some or all of their advantages. For instance, it is expressly contemplate that the components and/or elements described herein cat be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A method comprising:
mapping each of a plurality of abstraction layer slots to a virtual context of a logical resource, wherein the virtual context is hosted by a respective virtual machine from among a pool of virtual machines;
identifying an available abstraction layer slot from among the plurality of abstraction layer slots;
reserving the available abstraction layer slot so that a corresponding virtual context of the logical resource can be served; and
marking the available abstraction layer slot as unavailable.

2. The method of claim 1, further comprising:
receiving a request from a device for the logical resource; and
assigning the available abstraction layer slot to the device.

3. The method of claim 1, wherein the logical resource is a virtual network resource.

4. The method of claim 3, wherein the logical network resource comprises one of a virtual firewall, a virtual router, a virtual private network (VPN), a virtual load balancer, a virtual wide area network (WAN) optimization platform, a virtual deep packet inspector, or a virtual traffic monitor.

5. The method of claim 1, wherein at least one of the plurality of abstraction layer slots is mapped to an entire virtual machine from among the pool of virtual machines.

6. The method of claim 1, further comprising:
determining an available slot count based on a number of available abstraction layer slots from among the plurality of abstraction layer slots;
when the available slot count lies outside a desired range, performing one of:
(i) provisioning at least one virtual machine and adding the at least one virtual machine to the pool of virtual machines, whereby one or more new virtual contexts hosted by the at least one virtual machine are mapped to one or more new available abstraction layer slots in the plurality of abstraction layer slots, or
(ii) removing at least one virtual machine from the pool of virtual machines, whereby one or more superfluous abstraction layer slots, mapped to virtual contexts hosted by the at least one virtual machine, are removed from the plurality of abstraction layer slots; and
adjusting the available slot count.

7. The method of claim 6, wherein the desired range comprises a lower bound and an upper bound, and wherein one of the lower bound or the upper bound is determined based on a target number of available abstraction layer slots.

8. The method of claim 1, further comprising:
raising a deficit flag when a number of available abstraction layer slots falls below a threshold; and
when the deficit flag is raised, adjusting the number of available abstraction layer slots by provisioning at least one additional virtual machine that hosts at least one new virtual context of the logical resource, the at least one new virtual context being mapped to at least one new abstraction layer slot in the plurality of abstraction layer slots.

9. The method of claim 1, wherein marking the available abstraction layer slot as unavailable yields an unavailable abstraction layer slot, the method further comprising:
releasing the unavailable abstraction layer slot so that the corresponding virtual context of the logical resource can be reserved at a later time; and
marking the unavailable abstraction layer slot as available.

10. The method of claim 9, wherein the unavailable abstraction layer slot is released when a deletion trigger event for the logical resource occurs.

11. A system comprising:
a processor;
a pool of virtual machines; and
a computer-readable medium storing instructions which, when executed by the processor, cause the processors to perform operations comprising:
mapping each of a plurality of abstraction layer slots to a virtual context of a logical resource, wherein the virtual context is hosted by a respective virtual machine from among the pool of virtual machines;
identifying an available abstraction layer slot from among the plurality of abstraction layer slots;
reserving the available abstraction layer slot so that a corresponding virtual context of the logical resource can be served; and
marking the available abstraction layer slot as unavailable.

12. The system of claim 11, wherein the computer-readable storage medium stores additional instructions which, when executed by the processor, cause the processor to perform the operations further comprising:
receiving a request from a device for the logical resource; and
assigning the available abstraction layer slot to the device.

13. The system of claim 11, wherein the logical resource is a logical network resource comprising one of a virtual firewall, a virtual router, a virtual private network (VPN), a virtual load balancer, a virtual wide area network (WAN) optimization platform, a virtual deep packet inspector, or a virtual traffic monitor.

14. The system of claim 11, wherein at least one of the plurality of abstraction layer slots is mapped to an entire virtual machine from among the pool of virtual machines.

15. The system of claim 11, wherein the computer-readable storage medium stores additional instructions which, when executed by the processor, cause the processor to perform the operations further comprising:
determining an available slot count based on a number of available abstraction layer slots from among the plurality of abstraction layer slots;
when the available slot count lies outside a desired range, performing one of:
(i) provisioning at least one virtual machine and adding the at least one virtual machine to the pool of virtual machines, whereby one or more new virtual contexts hosted by the at leas one virtual machine are mapped to one or more new available abstraction layer slots in the plurality of abstraction layer slots, or
(ii) removing at least one virtual machine from the pool of virtual machines, whereby one or more superfluous abstraction layer slots, mapped to virtual contexts hosted by the at least one virtual machine, are removed from the plurality of abstraction layer slots; and
adjusting the available slot count.

16. The system of claim 15, wherein the desired range comprises a lower bound and an upper bound, and wherein one of the lower bound or the upper bound is determined based on a target number of available abstraction layer slots.

17. A non-transitory computer-readable storage medium storing instructions which, when executed by a processor, cause the processor to perform operations comprising:
mapping each of a plurality of abstraction layer slots to a logical resource hosted by a virtual machine from among a pool of virtual machines;
identifying are available abstraction layer slot from among the plurality of abstraction layer slots;
reserving the available abstraction layer slot so that a corresponding logical resource can be served; and
marking the available abstraction layer slot as unavailable.

18. The on-transitory computer-readable storage medium of claim 17, storing additional instructions which, when executed by the processor, cause the processor to perform the operations further comprising:
raising a deficit flag when a number of available abstraction layer slots falls below a threshold; and
when the deficit flag is raised, adjusting the number of available abstraction layer slots by provisioning at least one additional virtual machine that hosts the logical resource, the logical resource being mapped to at least one new abstraction layer slot in the plurality of abstraction layer slots.

19. The non-transitory computer-readable storage medium of clan 17, wherein remarking the available abstraction layer slot as unavailable yields an unavailable abstraction layer slot, the non-transitory computer-readable storage medium storing additional instructions which, when executed by the processor, cause the processor to perform the operations further comprising:
releasing the unavailable abstraction layer slot so that the corresponding logical resource can be reserved at a later time; and
marking the unavailable abstraction layer slot as available.

20. The non-transitory computer-readable storage medium of claim 19, wherein the unavailable abstraction layer slot is released when a deletion trigger event for the logical resource occurs.
